(19) United States
(12) Patent Application Publication
(10) Pub. No.: US 2008/0199740 A1
(43) Pub. Date: Aug. 21, 2008

(54) Interconnect of a planar fuel cell array

(75) Inventors: Sarbjit Singh Giddey, Glen Waverley (AU); Fabio T. Ciacchi, Clayton (AU); Sukhvinder P.S. Badwal, Clayton (AU)

Correspondence Address: LAHIVE & COCKFIELD, LLP, ONE POST OFFICE SQUARE, BOSTON, MA, 02109, US

(73) Assignee: Commonwealth Scientific and Industrial Research Organisation, Campbell (AU)

(21) Appl. No.: 11/708,394

(22) Filed: Feb. 20, 2007

(51) Int. Cl. H01M 8/00; H01M 2/08; H01M 6/02; H01M 6/42

(52) U.S. Cl. 429/12; 29/623.1; 429/122; 429/160; 429/185

(57) ABSTRACT

An electrochemical device including a series of interconnected electrochemical units, each of the electrochemical units including a membrane electrode assembly arranged between a first conductive surface and a second conductive surface and wherein: the first conductive surface preferably can include at least one conductive tab overlapping a conductive tab of the second conductive surface of an adjacent electrochemical unit, the first and second conductive tabs being electrically interconnected to one another.

### FIELD OF THE INVENTION

The present invention relates to the field of planar fuel cells and, in particular discloses a method of forming in-plane series interconnects in planar array fuel cells.

### BACKGROUND OF THE INVENTION

A fuel cell is an electrochemical device that converts chemical energy of a fuel (such as hydrogen or methanol) and oxidant (oxygen from air) into electrical energy and heat. The fuel cell has all the attributes of a battery, except that a fuel cell continues to produce electricity as long as fuel and oxidant are available, as opposed to a battery that stops producing power when the stored chemicals are exhausted. Several different types of fuel cells are under development. Amongst these, polymer electrolyte membrane (PEM) fuel cell is regarded as the most suitable technology for transport and small scale distributed power generation applications, because they operate at low temperatures (70-80° C.) and offer rapid start and shut down, unlimited thermal cycling capability and excellent load following characteristics. Around 50% of the power is available at cold start. A conventional polymer electrolyte membrane fuel cell stack consists of a number of cells called membrane electrode assemblies (MEAs). Each MEA, with air as the oxidant and hydrogen as the fuel would produce about IV signal under open circuit conditions (when there is no current flowing through the cell)/However, under load, the voltage per MEA reduces to between 0.4 and 0.8V with current densities in the range 100 to 700 mA.cm⁻². A number of these MEAs are assembled together in series with the help of interconnect (bipolar middle and unipolar end ones) plates to produce the required stack voltage and power. Each cell (or MEA) consists of a proton conducting polymer membrane sandwiched between a hydrogen (anode) electrode and an oxygen (cathode) electrode. The interconnect plates serve dual purpose: to electrically connect one cell to the other (to conduct electrical current) and to distribute reactants (as well collect products) to (from) the respective electrodes of the MEAs. Hydrogen and air (source of oxygen) are supplied to the electrodes via flow field gas channels in the interconnect plates. On shorting the cell (or stack) through an external load hydrogen supplied to the anode gets oxidised to protons and electrons. Electrons travel through the external load and protons are transported through the membrane to the cathode, where they react with the oxygen supplied to cathode side and electrons from the external load to produce water as per following reactions.

At anode (Hydrogen electrode): H₂=2H⁺+2e

At cathode (Air electrode): 2H⁺+½O₂+2e=H₂O

The oxygen depleted air along with the water formed on the air side of the MEA electrodes are collected by the gas flow channels. The air supplied to the oxygen electrode in addition to supplying oxygen, also helps in the removal of water formed at the electrode and thereby uncovering the reaction sites for more oxygen (air) access for the reaction.

In case of micro fuel cells for portable power applications, the fuel cell system is required to be smaller, simpler (without or less moving parts) and easily manufacturable at mass scale. This is where the concept of self air breathing (no air compressors for oxygen supply to fuel cell, no air side interconnect with flow channels for air), passive operation (no moving parts), miniaturisation of components (interconnects, micro fluid flow channels, overall system) and cheap fabrication methods have to be introduced to compete with batteries. There are two main configurations under development—stacking arrangement and planar or flat plate array design. In planar configuration the individual cells are laid flat side by side in a single plan, and whole oxygen (air) electrode side active area of each cell is exposed to atmospheric air for oxygen supply, water and heat exchange with the atmosphere. Further, the configuration allows easy integration with electronic appliances such as mobile phones and lap top computers. Typically the operating temperature of the self air breathing fuel cells is below 50° C. In a stacking arrangement, cells are stacked one above the other with the help of bipolar interconnect plates, and therefore it is difficult to provide direct atmospheric access to air side electrodes of the stack. The stacking arrangement is generally used for larger size stacks (>10 Wₑ range). In a stacked arrangement the series connection between one cell to the next cell is in-built as the interconnect plate between any two cells acts as a bipolar plate, and therefore no special connections are required to be made between cells. Secondly, the resistive losses due to connection between cells are expected to be very low (basically it's the resistance of the bipolar plate across its thickness). However, in a planar array configuration series connection has to be established between individual cells.

A number of planar type fuel cells are known in the art. For example, U.S. Pat. Nos.: 7,105,244, 6,969,563, 6,689,502, 6,680,139, 6,054,228, and 5,989,741, contents of which are hereby incorporated by cross-reference, disclose planar type fuel cell arrays.

When constructing planar fuel cell arrays, there remains a problem of how to interconnect the individual fuel cell elements.

For example, FIG. 1 shows an example schematic of a series connection made in the case of a planar 8-cell stack 10. In this diagram, cathode (oxygen side) of cell 1 is connected to the anode (Hydrogen side) of cell 2, and cathode of cell 2 is connected to the anode of cell 3, and so on. The anode 11 of cell 1 and cathode 12 of cell 8 are respectively the negative and positive terminals of the planar 8-cell stack.

FIG. 2 shows a schematic view of the multi-cell fuel interconnect of the 8-cell stack. It consists of interconnects e.g. 12 (with flow channels for fuel distribution to the anode) for 8 cells on an insulating substrate plate 13. These interconnects can be fabricated from any electrically conducting, non porous and corrosion resistant material such as graphite or any other metal that does not corrode in the fuel cell environment or has a protective coating to avoid corrosion. Interconnects along with the substrate plate can be manufactured using several techniques. There can be different designs of the fuel manifolding for distribution of the fuel to different interconnects, for example from the front or from the back side of the substrate.

FIG. 3 shows a schematic view of the multi-cell air interconnect of the 8-cell stack. It consists of perforated (for self air breathing) interconnects 15 for 8 cells on an insulating substrate plate 14. These interconnects can be fabricated from graphite or any other corrosion resistant metallic material.

FIG. 4 illustrates a multi-cell membrane electrode assembly (MEA), consisting of 8 cells (assembled using a single membrane for all the cells or individual membrane for each cell) e.g. 20 is assembled between the multi-cell fuel side interconnect and the multi-cell air interconnect.

As illustrated schematically in FIG. 5, in order to achieve a series connection between the cells, the connections 22 are required to be made between the fuel interconnect (anode) of one cell to the air (cathode) interconnect of the next cell using some form of an external electrical connection around the edge of the each cell without shorting the positive and negative electrodes in the planar array.

In a planar array arrangement, this technique of making the series connection between the cells has several limitations.
The array using this kind of arrangement for series connection would be limited to only small number of arrays due to the number of connectors crossing over each other on the array backside and edges, and keeping these wires insulated from each other.
Due to number of these wires or strips making connection between fuel interconnects and air interconnects, fuel side sealing is difficult due to the external connections to the electrodes.
The connections may have to be made individually between cells, which is a labour intensive process and does not warrant the fuel cell unit assembling process to be an automatic assembly process.
The voltage losses due to these connections (soldering, length of connectors) can be excessively higher resulting in low fuel cell unit power output (low performance) and higher temperatures.
Miniaturisation of the fuel cell unit to suit the application can be difficult due to soldering, external connectors, insulations etc.

### SUMMARY OF THE INVENTION

It is an object of the present invention to provide an improved form of interconnections between cells of the planar array of a fuel cell device.

In accordance with a first aspect of the present invention, there is provided an electrochemical device including a series of interconnected electrochemical units, each of the electrochemical units including a membrane arranged between a first conductive surface and a second conductive surface and wherein: the first conductive surface preferably can include at least one conductive tab overlapping a conductive tab of the second conductive surface of an adjacent electrochemical unit, the first and second conductive tabs being electrically interconnected to one another.

The first and second conductive tabs are preferably spaced apart from one another and substantially parallel to one another and are preferably electrically interconnected by a conductive material placed between the first and second conductive tabs. Alternatively, the first and second conductive tabs can include mating surfaces electrically interconnecting one another. The first and second conductive surfaces are preferably profiled for directing fluid flows between the surfaces and the membrane electrode assembly (MEA).

The tabs extend beyond the flow field of the interconnect.

The electrochemical units are preferably formed around apertures in a nonconductive plate. The tabs are preferably formed from coated copper material having a corrosion resistant covering. The device can comprise an air breathing fuel cell. The series of interconnected electrochemical units are preferably arranged in an array. The series of interconnected electrochemical units are preferably electrically connected in series.

In accordance with a further aspect of the present invention, there is provided a method of interconnecting a series of electrochemical cells to form an electrochemical device, the method comprising the steps of: (a) forming a series of electrochemical cells having a first and second conductive surfaces on opposite sides of a surrounding membrane and defining flow fields there between, the first and second conductive surfaces including mating tabs extending beyond the flow fields; (b) electrically mating the first conductive surface of a first surface with the second conductive surface of an adjacent electrochemical cell.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:

FIG. 1 illustrates schematically the serial electrical interconnection of a planar fuel cell;

FIG. 2 illustrates schematically the hydrogen interconnect layer of a planar fuel cell;

FIG. 3 illustrates schematically the air/oxygen interconnect layer of a planar fuel cell;

FIG. 4 illustrates schematically the membrane electrode layer of a planar fuel cell;

FIG. 5 illustrates schematically the problem of serial interconnection of individual fuel cells in a planar arrangement;

FIG. 6 illustrates schematically the hydrogen interconnect layer of a planar fuel cell in accordance with the preferred embodiment;

FIG. 7 illustrates schematically the air/oxygen interconnect layer of a planar fuel cell in accordance with the preferred embodiment;

FIG. 8 illustrates schematically the combined fuel cell arrangement of the preferred embodiment;

FIG. 9 is a top plan view of a fuel cell arrangement of the preferred embodiment;

FIG. 10 is a sectional view of the arrangement of FIG. 9;

FIG. 11 is a schematic sectional view of a series interconnection in a fuel cell arrangement of the preferred embodiment; and

FIG. 12 is a graph of the output power of one arrangement formed in accordance with the preferred embodiment.

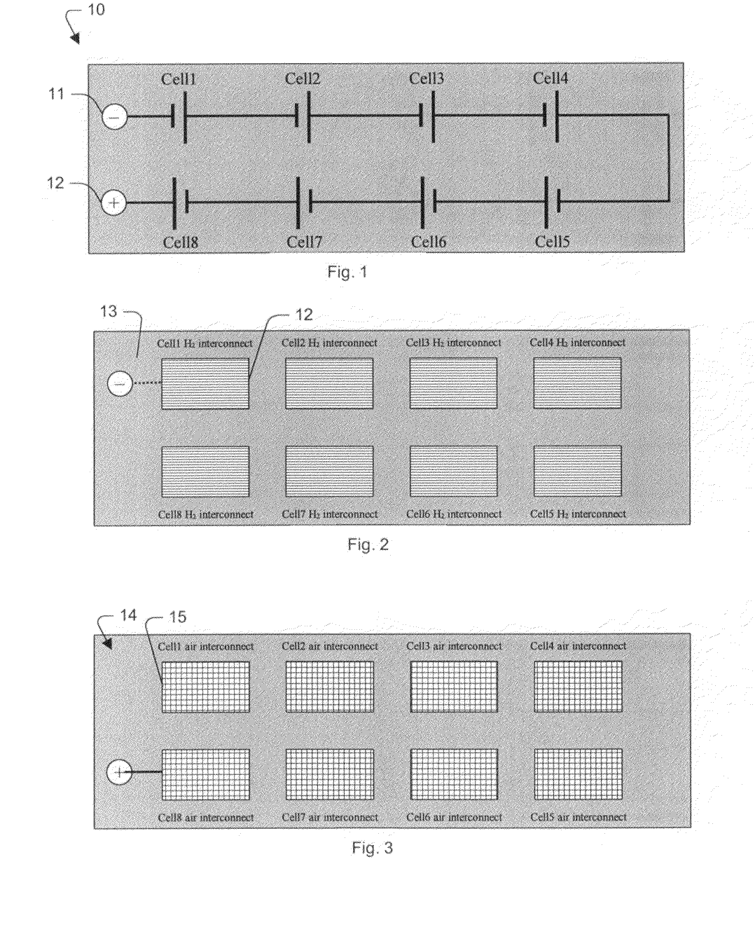

### DESCRIPTION OF THE PREFERRED AND OTHER EMBODIMENTS

In the preferred embodiments, in order to alleviate the above limitations, a design and assembly process has been developed for internal series electrical connection between the cells in a self air breathing planar fuel cell array.

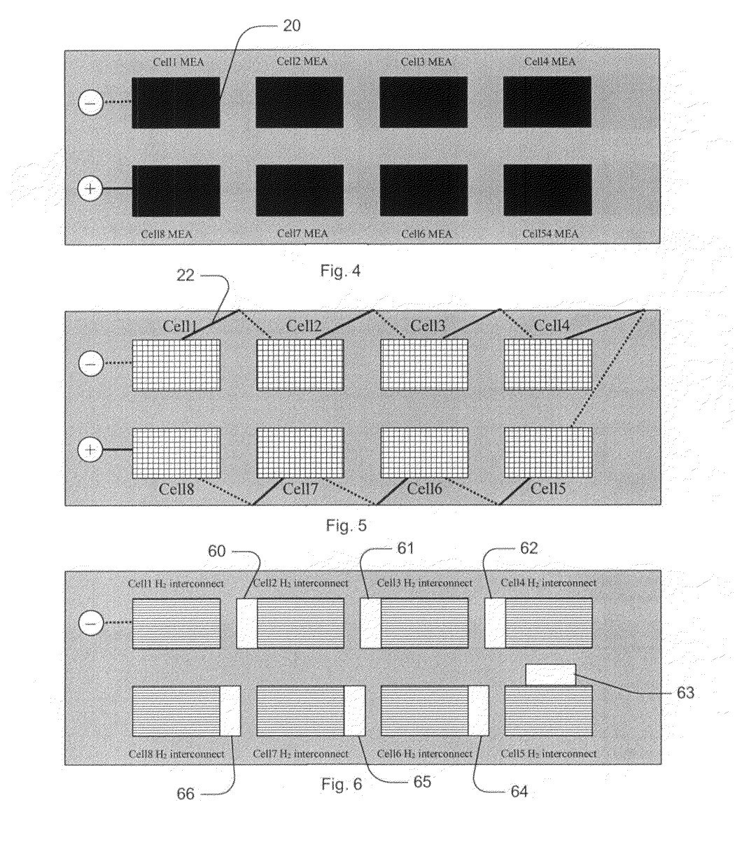

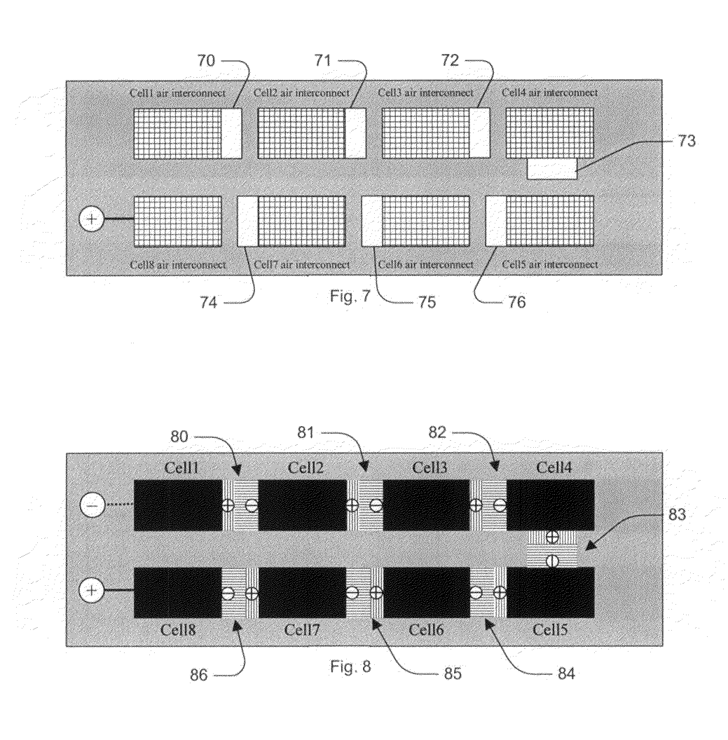

Turning to FIG. 6 and FIG. 7, in the planar array fuel cell unit assembly, each of the fuel and oxygen interconnects have extended conductive tabs (60-66 and 70-76 respectively) beyond the respective flow field areas. These tabs are designed, positioned and constructed in such a way that the fuel tabs (negative terminal 60-66) of one cell overlaps the oxygen tab (positive terminal 70-76) of the next cell.

FIG. 8 illustrates the combined overlap. The internal electrical connection is achieved by placing an electrically conducting material through the electrolyte membrane in the region 80-86 between the opposed overlapping tabs. The fuel sealing is easily achieved by using a gasket around the electrodes and conducting material, on either side of the membrane.

This type of internal series connection allows any number of arrays of cells depending on design requirements. This provides enormous flexibility in terms of power output (voltage and current) to suit the appliance. The connections between the cells are achieved in one step, which is advantageous for mass production of these devices. The connection path between the fuel interconnect (anode) of one cell to the air interconnect (cathode) of the next cell has been substantially reduced, resulting in lower voltage losses between cells and higher performance. Further this results in lower operating temperatures. The internal series connections would make fuel sealing easier. The absence of soldering, connection wires and one step assembly process allows for miniaturisation of the whole fuel cell unit. The series connection also makes it easier to use technologies such as PCB, lithography etc. for fabrication of multi-cell fuel and oxidant interconnects.

This invention of making connection between cells of a planar fuel cell array can be employed to construct a self air breathing planar fuel cell device with any number of cells and arrays to suit the application (in terms of its power requirements, size and shape). This design can be further exploited for conventional fuel cell stacks (multi-cell planar (N×N array) modular stacking) and for hybrid micro/small fuel cell systems ideally in the 100-500 W range.

One particular implementation of the arrangement of the invention will now be described. Conventional fuel cells require the supply of compressed air to the oxygen electrode of the fuel cell to supply oxygen and to remove water produced by the electrochemical reaction. This increases the complexity of the system in portable power applications. However, if the oxygen electrode of each fuel cell in the assembled array can be exposed to atmospheric air, the cells can self breath oxygen from atmosphere.

This requirement can be achieved by placing cells horizontally in a planar configuration, whereby all the respective oxygen electrodes of the cells are on one side and the hydrogen electrodes are on the other side. Although this arrangement simplifies the hydrogen gas manifolding, it severely complicates the electrical series connection from cell to cell in the array as oxygen electrode of one cell needs to be connected to hydrogen electrode of the next cell. This can be achieved by having the hydrogen and oxygen electrodes connected externally around the edge of the electrolyte membrane used in the array. However, as described earlier, there are many disadvantages of connecting cells externally. The preferred embodiments of the present invention describes the improved form of internal interconnections between cells of the planar array of a fuel cell device.

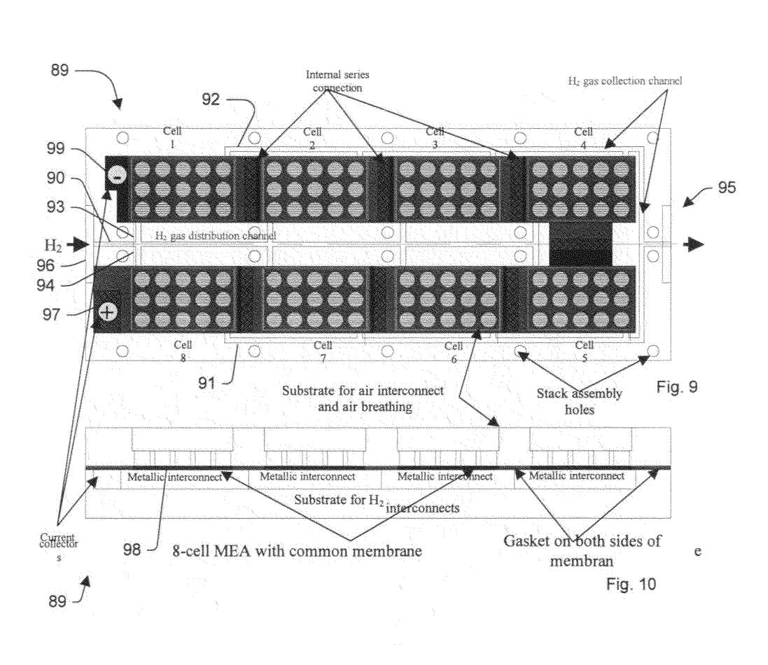

Turning to FIG. 9 and FIG. 10, in one example embodiment, an 8-cell (each cell of active area 4 cm²−26 mm×15.3 mm) self air breathing micro fuel cell unit 89 was designed and constructed using the series connection methodology as described above. The main components of the fuel cell unit were a multi-cell (8 cells) membrane electrode assembly (MEA), hydrogen interconnect plate and an air side interconnect plate as shown schematically in FIG. 9. The detailed description of the fuel cell unit components, assembling and performance is given below.

### Hydrogen Interconnect Plate

The hydrogen interconnect plate consists of eight interconnect plates (2 rows—each consisting of 4 cells) embedded in a polycarbonate substrate of thickness 12.5 mm and cross section 150 mm×60.2 mm. This substrate can also be fabricated from any other non conducting material such as acrylic (Perspex, nylon etc.) or ceramic materials and may be of any suitable thickness. Interconnects were nickel coated copper blocks, each of thickness 5 mm. Each interconnect has a 2-channel parallel serpentine flow field consisting of 300 μm×300 μm cross section channels and ribs, with an extended tab with no flow field formed. These tabs are used for series electrical connection between the cells and for current collection.

In one form the interconnects may be made from graphite, a metal or a metallised non conducting substrate, in the form of a block or a sheet. The flow fields in interconnects may be machined, stamped, etched or moulded. Further, these interconnects may be coated with a corrosion resistant protective coating by one of the several methods such as physical vapour deposition (PVD), spraying, electroplating, thermo chemical deposition etc.

In another variation the complete multi-cell hydrogen interconnect can be fabricated from metallised non conducting substrate.

### Hydrogen Gas Manifolding

FIG. 9 shows the hydrogen gas manifolding arrangement in the hydrogen interconnect plate of the fuel cell unit. A single hydrogen supply channel 90 for distributing gas to individual interconnects was milled in the centre of the polycarbonate plate. Two collection channels 91, 92 for collecting gas from interconnects were milled on the outer sides of the polycarbonate plate. These channels were covered with stainless steel strips levelled with the substrate plate surface. The gas was distributed to flow field channels through 1 mm diameter horizontal ports e.g. 93, 94 between the main gas supply channel and flow field. These horizontal ports were then connected to the flow channels of interconnects by drilling vertical holes at the entrance of the serpentine flow field. The hydrogen inlet 96 and exit 95 connections to the interconnect plate were made by installing a stainless steel plate welded to a stainless steel tube on both sides of the polycarbonate plate.

### Air Interconnect Plate

The conducting air interconnects of individual cells can be embedded in a non conducting substrate material such as acrylic (Perspex, nylon etc.) or ceramic materials as shown in FIGS. 3 and 9. The air interconnects with perforations for air breathing can also be made by machining or any other method of selective metal removal to generate the required pattern of air breathing perforations.

In another variation the whole multi-cell air breathing interconnect plate can be fabricated using PCB technology. The PCB boards are already laminated with a copper foil. The perforated air interconnects can be made using combination of electro etching, machining and electroplating techniques. The copper interconnects can be then coated with a corrosion resistant metal or alloy coatings.

### Membrane Electrode Assembly 98

Nafion N112 (50 μm thick) from Dupont was used as a proton conducting membrane, A single piece of membrane was used for the multi-cell MEA. In another variation proton conducting membrane of other thicknesses such as Nafion N115, N117 or proton conducting membranes from other suppliers can also be employed for MEA fabrication, and there are several possible variations to membrane treatment process. MEA for the planar array can be either made from a single membrane in one step hot pressing of all cells, or can also be made individually. There are several variations possible in fabrication of fuel and oxygen electrodes such as electrode backing, diffusion layer, catalyst layer, ionomer layer, hot pressing process conditions.

### Gaskets

Silicone rubber gasket sheets of different thicknesses were used on both sides of the multi-cell membrane electrode assembly. Apart from windows for electrodes of the 8-cell MEA, narrow rectangular windows between the cells were cut for series connection between the cells as explained below.

### Series Connection and Current Collection

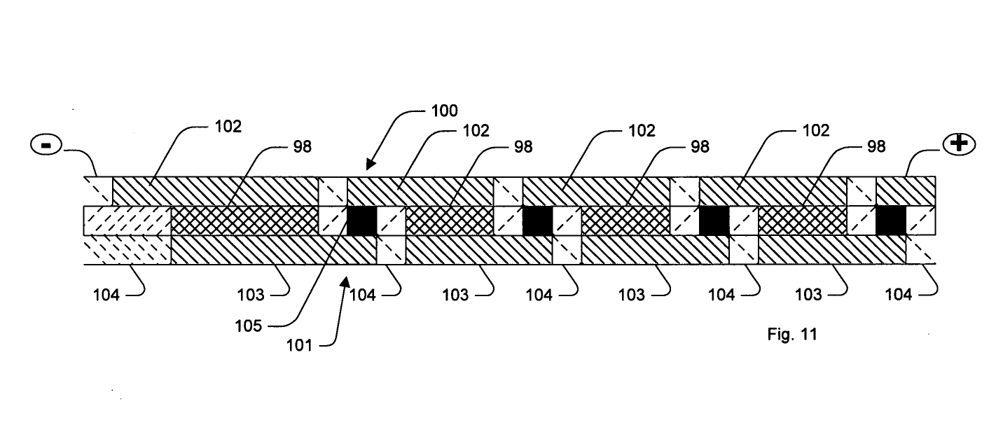

As seen in FIG. 11, each of the hydrogen and oxygen interconnects have extended tabs beyond the respective flow field areas. These tabs are designed, positioned and constructed in such a way that the oxygen tab (positive terminal) of one cell e.g. 100 (for example cell 1) overlaps the hydrogen tab (negative terminal) of the next cell (cell 2) e.g. 101.

The internal electrical connection is achieved by placing an electrically conducting material (carbon paper strips) 105 through the electrolyte membrane and between these opposing tabs. In a variation in place of carbon paper, it can be any other electrically conducting material such as carbon cloth, woven metallic mesh, metal nails etc. The gas sealing is easily achieved by the gasket around the electrodes on either side of the membrane. Further, non-conductive material 104 such as polycarbonate is utilised to hold each cell in place.

As shown in FIG. 9, the current collection connections have been made to extended tab of hydrogen interconnect of cell 99 (negative terminal) and extended tab of air interconnect of cell 97 (positive terminal). A copper block embedded in the polycarbonate substrate of multi-cell hydrogen interconnect was used for current collection from positive terminal of cell 8.

In another variation, the overlapping areas of interconnects (extended tabs beyond flow field channels) can be raised to make a direct contact (through the electrolyte membrane) with each other and even avoid a conducting material (such as carbon paper or carbon cloth) as mentioned in the invention.

### Fuel Cell Unit Assembly

The 8-cell MEA sandwiched between the gaskets is installed on the hydrogen interconnect. Carbon paper strips are inserted into the narrow windows between the cells for series connection and current collection. Self air breathing multi-cell interconnect is then installed on top of MEA with air interconnects facing the MEA electrodes. The unit is assembled in a way to ensure sealing and good contact between components without damaging the MEA.

### Fuel Cell Unit Performance Evaluation

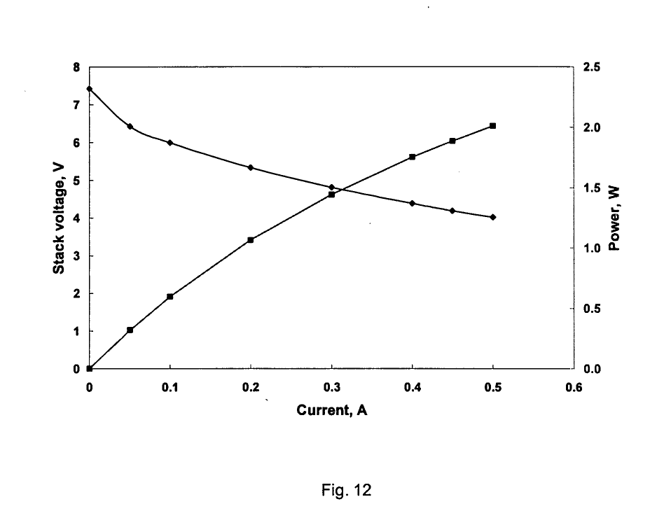

A fuel cell device was operated on industrial grade hydrogen, initially in a flow through mode and then changed to flow through/dead end cycles. The OCV value of the fuel cell device was 7.18V, and for individual cells it was in the range 0.867V-0.962V, with an average value of 0.9V per cell. FIG. 12 shows Voltage—current characteristics of the fuel cell device. The peak power output obtained from the fuel cell device was 2.065 W (0.5 A/4.13V). The surface temperature of the fuel cell device was around 32° C. (Lab temperature 25° C.).

A number of further modifications are possible. These include:
In an alternative embodiment, the overlapping areas of interconnects (extended tabs beyond flow field channels) can be raised to make a direct contact (through the electrolyte membrane) with each other and even avoid a conducting material (such as carbon paper or carbon cloth).
   The gas tight sealing obtained around the interconnects and ‘series connection tabs’ can be achieved instead of using silicone rubber sheet, by using ‘hot set’ or ‘hot melt’ adhesives in the form of films or liquids that work as adhesives as well as gaskets.
   The in-plane series connection concept has been demonstrated for planar PEM fuel cell on hydrogen as a fuel, but can be employed in a fuel cell unit of any type, and for any type of fuel (methanol, ethanol etc.) and oxidant (oxygen, air—self breathing or forced).

Although the present invention has been described with particular reference to certain preferred embodiments thereof, variations and modifications of the present invention can be effected within the spirit and scope of the following claims.

We claim:

1. An electrochemical device including a series of interconnected electrochemical units, each of said electrochemical units including a membrane electrode assembly arranged between a first conductive surface (oxygen electrode side) and a second conductive surface (fuel electrode side) and wherein:
the first conductive surface includes at least one conductive tab overlapping a conductive tab of the second conductive surface of an adjacent electrochemical unit, said first and second conductive tabs being electrically interconnected to one another.

2. An electrochemical device as claimed in claim 1 wherein said first and second conductive tabs are spaced apart from one another and substantially parallel to one another and are electrically interconnected by a conductive material placed between the first and second conductive tabs.

3. An electrochemical device as claimed in claim 1 wherein said first and second conductive tabs include mating surfaces electrically interconnecting one another.

4. An electrochemical device as claimed in claim 1 wherein said first and second conductive surfaces are profiled for directing fluid flows between the surfaces and a membrane electrode assembly.

5. An electrochemical device as claimed in claim 1 wherein said tabs extend beyond the flow field of the interconnect.

6. An electrochemical device as claimed in claim 1 wherein said electrochemical units are formed around apertures in a nonconductive plate.

7. An electrochemical device as claimed in any previous claim wherein said tabs are formed from coated copper material having a corrosion resistant covering.

8. An electrochemical device as claimed in claim 1 wherein said device comprises an air breathing fuel cell.

9. An electrochemical device as claimed in claim 1 wherein said series of interconnected electrochemical units are arranged in an array.

10. An electrochemical device as claimed in claim 1 wherein said series of interconnected electrochemical units are electrically connected in series.

11. An electrochemical device as claimed in claim 1 wherein the interconnected electrochemical interconnect units are embedded in a non-conducting material layer.

12. An electrochemical device as claimed in claim 11 wherein said non-conducting material layer comprises acrylic, plastic or ceramic material of predetermined thickness.

13. An electrochemical device as claimed in claim 2 wherein said conductive material comprises one of graphite, a metal or a metallised surface of a non conducting substrate.

14. An electrochemical device as claimed in claim 1 wherein the first or second conductive surface include fluid flow fields.

15. An electrochemical device as claimed in claim 14 wherein said flow fields are machined, stamped, etched or moulded into said surfaces.

16. An electrochemical device as claimed in claim 1 wherein the surfaces are coated with a corrosion resistant protective coating.

17. An electrochemical device as claimed in claim 16 wherein the corrosion resistant protective coating is formed by one of physical vapour deposition (PVD), spraying, electroplating or thermo chemical deposition.

18. An electrochemical device as claimed in claim 1 wherein the first conductive surface is formed from metallisation on a non-conducting substrate.

19. An electrochemical device as claimed in claim 18 wherein the first conductive surface of each of the electrochemical units is from selective metallisation of the same non-conducting substrate.

20. An electrochemical device as claimed in claim 1 wherein the overlapping conductive tabs include raised portions for making conductive contact with predetermined other surfaces.

21. An electrochemical device as claimed in claim 1 wherein a gas tight seal is provided around each electrochemical unit by means of a ‘hot set’ or ‘hot melt’ adhesive.

22. A method of interconnecting a series of electrochemical cells to form an electrochemical device, the method comprising the steps of:
(a) forming a series of electrochemical cells having a first and second conductive surfaces on opposite sides of a surrounding membrane electrode assembly and defining flow fields therebetween, said first and second conductive surfaces including mating tabs extending beyond the flow fields;
(b) electrically mating the first conductive surface of a first surface with the second conductive surface of an adjacent electrochemical cell.
